(19) United States
(12) Patent Application Publication
(10) Pub. No.: US 2009/0323332 A1
(43) Pub. Date: Dec. 31, 2009

(54) LED ILLUMINATION DEVICE

(76) Inventors: Chih-Wei LO, Jhonghe City (TW); I-Lin CHU, Jhonghe City (TW)

Correspondence Address: Muncy, Geissler, Olds & Lowe, PLLC, P.O. BOX 1364, FAIRFAX, VA, 22038-1364, US

(21) Appl. No.: 12/493,683

(22) Filed: Jun. 29, 2009

(30) Foreign Application Priority Data
Jun. 30, 2008 (TW) 097124626

(51) Int. Cl. F21V 1/00

(52) U.S. Cl. 362/235

(57) ABSTRACT

A LED illumination device is revealed. The LED illumination device includes a LED array and a holder. The LED array is formed by a plurality of LED arranged in a specific pattern. The holder is covered in front of the LED array for waterproof protection. A hole array is disposed on a corresponding plate of the holder and the corresponding plate faces the LED array. A plurality of second lenses for LED are respectively mounted into each hole of the hole array so as to form a second lens array. Thus light emitted from the LED array passes through the second lens array to be projected.

### BACKGROUND OF THE INVENTION

The present invention relates to a light-emitting diode (LED) illumination device, especially to a LED array covered closely by a holder on a front side thereof. A plurality of holes disposed on the holder form a hole array. A plurality of second LED lenses is mounted in each hole respectively so as to form a second lens array. Thus light emitted from the LED array passes through the second lens array to be projected. The holder has double functions-providing optical function like the second LED lens and waterproof protection.

LED has been applied to various fields widely, acting as light sources such as flashlights, desk lamps, vehicle lamps (headlights and/or taillights), road lights or lighting accessories of electronics such as camera flashlights, scanning light source etc. A plurality of LED is arranged into an array that works as a light source. The arrangement of LED is not restricted. It can be various patterns such as linear patterns, array patterns, or concentric circle patterns and so on according to the requirements of the illumination devices. A LED basically is composed of a base being loaded with LED chips and at least one layer of cover lens made from transparent resin. The cover lens is generally called a first lens for LED that covers the base and the LED chip to form a LED assembly (abbreviated as LED in the following). In use, light from the LED chip passes through the first lens to be projected.

In applications, different LED lighting devices are used under various conditions. For example, the distance between the two road lights is about 15 to 30 meters and the road light height is approximately 6 to 20 meters so as to provide even and sufficient illumination on a rectangular area in which the ratio of the length to the width is 3:1 within a certain distance. In use, each LED is disposed with a second lens on the light emitting direction besides the basic first lens so as to improve efficiency of the LED light source. That means the increase of effective luminance (light intensity) (SI unit:lux=lumens per square metre (1 m/m²)), light loss reduction or adjustment of the effective area of LED and evenness of illumination. When the light passes through mediums, light loss occurs due to absorption or reflection on the interface between two mediums. Thus the effective luminance is reduced and the efficiency is further affected. Therefore the second lens is made from optical glass or optical plastic so as to reduce light loss during transmission. Moreover, the required optical surface on the second lens is formed by precision molding or plastic injection molding but is not restricted to these ways so as to improve the optical efficiency. However, the cost of optical glass or plastic is quite high and these materials are not suitable to produce optical elements with large areas. When the optical elements have larger volume or more optical surfaces, the production of the required mold is getting difficult and this is adverse to mass-production.

Furthermore, LED and related accessories such as circuit boards for receiving the LED are waterproof so as to avoid damages. Thus most of conventional illumination devices include a light shade (holder) for waterproof protection. However, the area of the light shade is quite large. Once the light shade is directly made from optical glass or plastic, this doesn't meet the requirements of economy, energy-saving and emission reduction. The manufacturing processes are with difficulties and are unable to be managed effectively. If the light shade is made from common glass or plastic materials, the LED light passes the second lens and the light shade before projection and the loss during transmission is increased. The light loss of general glass or plastic materials ranges from 8% to 15%. Thus the effective light intensity is reduced relatively. The efficiency of the illumination device is affected significantly.

Thus there is a need to develop an illumination device in which LED is used as light sources and the illumination device has features of small loss during transmission, high light intensity, easy manufacturing and assembling and low cost.

### SUMMARY OF THE INVENTION

Therefore it is a primary object of the present invention to provide a LED illumination device having a LED array and a holder. The LED array is formed by a plurality of LED arranged in a specific pattern and the holder is covered in front of the LED array for waterproof protection. A hole array is disposed on a corresponding plate of the holder and the corresponding plate faces the LED array. A plurality of second lenses for LED are respectively mounted into each hole of the hole array and integrated with each other so as to form a second lens array. Thus light emitted from the LED array passes through the second lens array to be projected. Therefore, the LED light loss during transmission is reduced, the effective luminance is increased and the optical efficiency and use efficiency of the illumination device is further improved.

It is another object of the present invention to provide a LED illumination device in which the pattern of the hole array on the holder is not restricted. The pattern is designed corresponding to the pattern of the LED array so that light from each LED of the LED array passes through the corresponding second lens mounted in the hole array to be projected. Thus the effective luminance is improved. The optical efficiency and use efficiency of the illumination device are also increased.

It is a further object of the present invention to provide a LED illumination device in which the shape of the hole of the hole array on the holder is not limited and is designed according to the shape of the second lens. Thus the mold design, optical surface design and manufacturing processes of the second lens are simplified. This helps improving the optical efficiency of the second lens and simplifying assembling of the illumination device.

### BRIEF DESCRIPTION OF THE DRAWINGS

FIG. 1 is a cross sectional view of an embodiment of a LED illumination device according to the present invention;

FIG. 2 is a top view of the embodiment in FIG. 1 in which a hole array of a holder is not mounted with a second lens according to the present invention;

FIG. 3 is another top view of the embodiment in FIG. 1 in which the correspondence between a second lens array and a LED array is one-to-one according to the present invention;

FIG. 4 is another top view of the embodiment in FIG. 1 in which the correspondence between a second lens array and a LED array is not one-to-one according to the present invention;

FIG. 5 is a cross sectional view of another embodiment of a LED illumination device according to the present invention.

### DETAILED DESCRIPTION OF THE PREFERRED EMBODIMENT

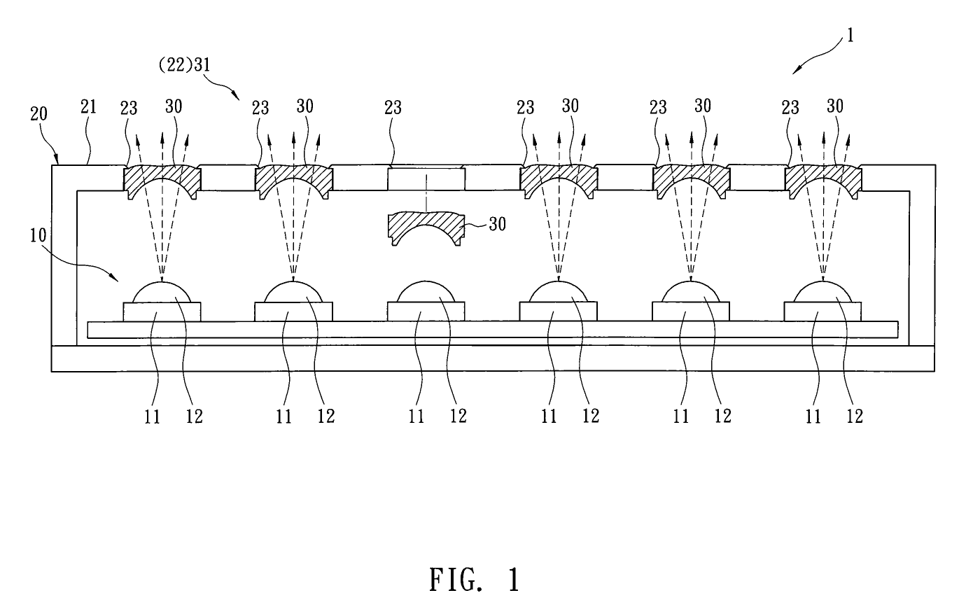

Refer from FIG. 1 to FIG. 3, a LED illumination device 1 of the present invention includes a LED array 10 and a holder 20. The shape, assembling way and size of the LED illumination device 1 are not restricted and can be modified according to requirements and fields of the applications. For example, the devices applied to various lights such as flashlights, table lamps, vehicle lamps (headlights and/or taillights), road lights or lighting accessories of electronics (camera flashlights and scanning light source) are with different design. In this embodiment, the road light is taken as an example, but not intended to restrict the scope of the present invention.

The LED array 10 includes a plurality of LED arranged in a specific pattern. The patterns are not limited. They can be linear patterns, array patterns, or concentric circle patterns and so on according to different requirements in different fields. The embodiment in FIG. 1 to FIG. 3 is a road light or similar object. The LED array 10 is a rectangular array with rows and columns. Moreover, each LED 11 is formed by a LED chip (not shown in figure) and a first lens 12. Light from the LED chip passes through the first lens 12 to be projected, as shown in FIG. 1. As to the package, assembling, lighting patterns, manufacturing processes and related circuit design of the LED 11 are not restricted and are designed according to structural requirements or use requirements.

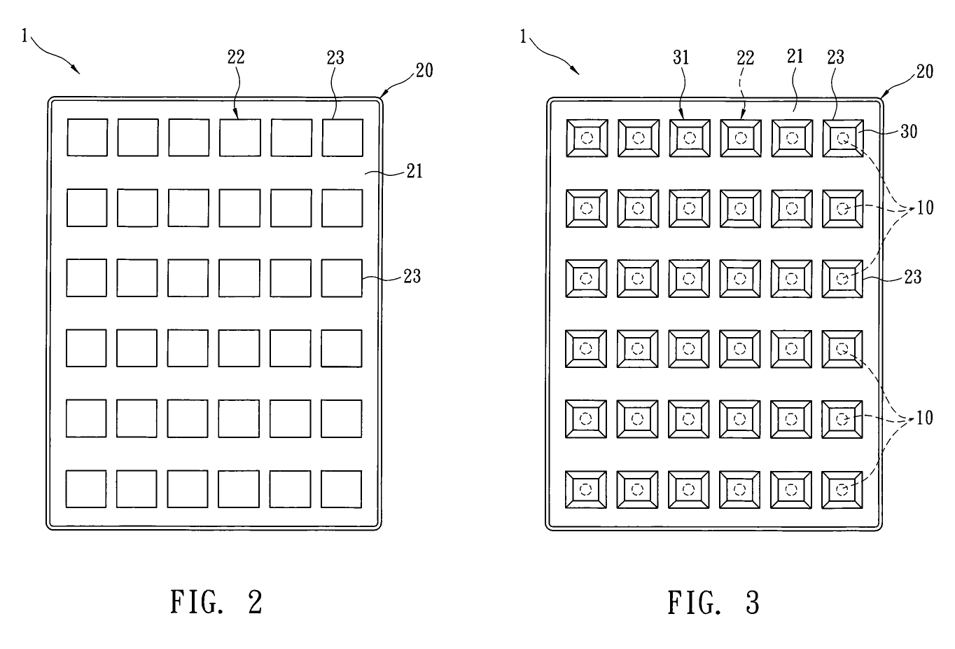

The holder 20 is covered in front of the LED array 10 closely so as to provide waterproof effect. As to the shape, assembling and size of the holder 20, there are no limits and they can be modified according to different fields of applications. For example, the holder 20 is an integrated part made by plastic injection molding, as shown in FIG. 1. Or it can also be a combination of multiple parts (not shown in figure). Furthermore, the holder 20 includes at least one corresponding plate 21 that faces the LED array 10. A hole array 22 is disposed on the corresponding plate 21, as shown in FIG. 2. The hole array 22 is formed by a plurality of holes 23 arranged in a specific pattern. The arrangement (pattern) of the hole array 22 is not restricted and it can be a line, an array or concentric circles. In the embodiment in FIG. 1 to FIG. 3, a road light or a similar object is taken as an example. The hole array 22 is a rectangular array and is symmetrical, corresponding to the LED array 10.

A plurality of second lenses 30 is mounted in each hole 23 of the hole array 22 respectively and is used in combination with the LED 11. The second lens 30 is integrated with the corresponding plate 21 of the holder 20 so that the plurality of second lenses 30 forms a second lens array 31. The shape and size of the second lens 30 are designed according to the hole 23 so that the second lens 30 can be mounted into and integrated with the hole 23 correspondingly. The connection way between the second lens 30 and the hole 23 is not limited. They can be fixed by glue to achieve waterproof effect. Moreover, there is no limit on design of optical surfaces of the second lens 30. The optical surface can be modified according to different requirements of applications. In this embodiment, a road light or a similar object is used as an example.

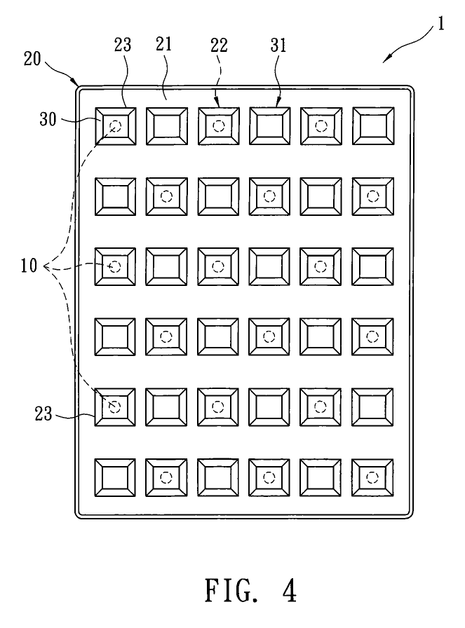

The pattern of the hole array 22 arranged at the corresponding plate 21 of the holder 20 is not restricted. It is preferred that the arrangement of the hole array 22 is corresponding to that of the LED array 10 so that the second lens array 31 formed also corresponds to the LED array 10, as shown in FIG. 3 & FIG. 4. Thus the second lens 30 can be used.

The design of the LED array 10, the hole array 22 and the second lens array 31 mentioned above can be modified according to users' needs. For example, the number of the LED 11 of the LED array 10 is not limited to one. Two LEDs 11 are disposed in parallel on one of the positions within the LED array 10. And the LEDs 11 used in the LED array 10 are not restricted to be with the same specification. Moreover, each hole 23 of the hole array 22 is not limited to be with the same shape or the same size. For example, the two adjacent holes 23 are connected with each other to form a larger hole whose size is about two times of the original hole. Then a second lens (30) whose size is two times of the second lens 30 is mounted into this new hole. Refer to FIG. 2 & FIG. 3, if each hole 23 of the hole array 22 has the same shape and the same size, the second lens 30 is designed to have the same specification and this is beneficial to mass production of the second lens 30. Thus the production cost is reduced. As shown in FIG. 3, each second lens 30 of the second lens array 31 corresponds to each LED 11 of the LED array 10. That means a LED 11 is added within the LED array 10, correspondingly to one of the second lens 30 of the second lens array 31. But the above arrangement is not limited to one-to-one correspondence. Refer to FIG. 4, the LED 11 of the LED array 10 is just disposed correspondingly to part of the second lens 30 of the second lens array 31. The second lens 30 not corresponding to the LED 11, without disposition of the LED 11, is replaced by a general second lens made from common glass or plastic to be mounted in the hole 23. Thus the number of the second lens 30 made from optical materials is reduced and the cost is down. In use, light emitted from each LED 11 of the LED array 10 passes through the second lens 30 of the second lens array 31 to be projected. Thus the effective luminance of LED is improved and both optical efficiency and use efficiency of the illumination device 1 are increased.

In the LED illumination device 1 of the present invention, a hole array 22 is disposed on the corresponding plate 21 of the holder 20 firstly. Then a plurality of second lenses 30 are respectively mounted into each hole 23 of the hole array 22. Thus the holder 20 (or the corresponding plate 21) and the second lens 30 are manufactured separately. And the shaped of the hole 23 within the hole array 22 is designed according to the shape of the second lens 30. Thus the design, manufacturing and production processes of the mold of the second lens 30 are easy and convenient. Moreover, the optical surfaces of the second lens 30 are easily to achieve optimal design and this is beneficial to improve the optical efficiency of the second lens 30. And the assembling of the illumination device 1 is simplified.

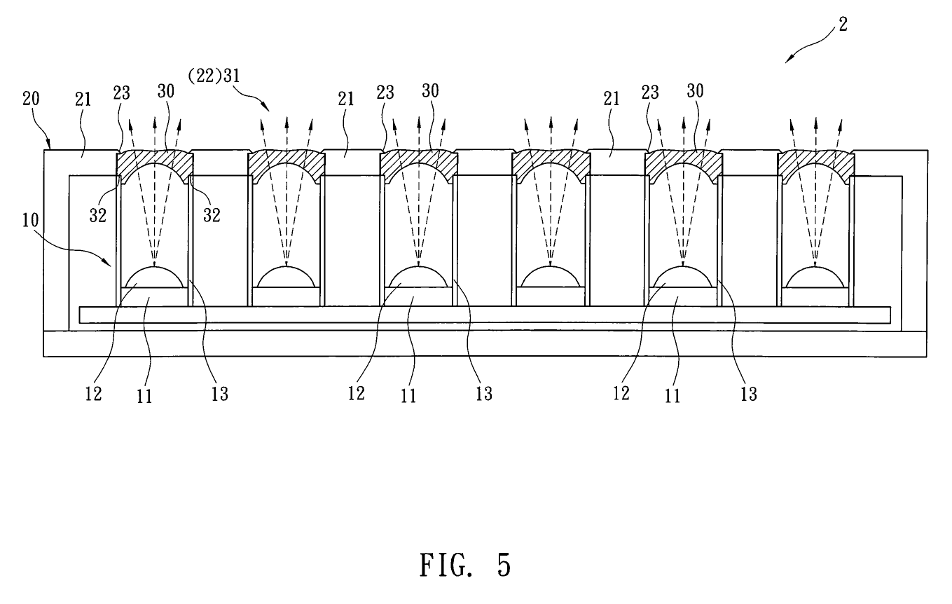

Refer to FIG. 5, the difference between a LED illumination device 2 in this embodiment and the above one is in that a LED 11 and a second lens 30 are integrated into one part by a barrel 13. A flange 32 is disposed around the circumference of the second lens 30 so as to lock with an upper edge of the barrel 13. Thus the second lens 30 is easily assembled on top of the barrel 13 to form a LED module. After finishing the assembling, the LED 11 and the second lens 30 are automatically aligned with each other by the connection of the barrel 13. Thus light from the LED chip passes the first lens 12, through the internal space of the barrel 13 and the second lens 30 to be projected outward. The design of the barrel 13 is beneficial to the simplification of the following assembling operations. While being assembled, the second lens 30 of the LED module is still mounted in the hole 23.

In summary, the holder 20 provides booth optical function and waterproof effect. The holder 20 includes the second lens 30. Thus the shortcoming of conventional LED light—the light loss caused by a protective transparent light shade covered outside the second lens is overcome. Moreover, the second lens 30 and the holder 20 are manufactured separately and then are assembled with each other. On the other hand, an integrated holder having a second lens whose whole structure is made from optical glass or plastic directly has lots of problems such as increases the cost, difficulties in the manufacturing processes and the control of the precision of the second lens. In comparison, the present invention achieves multiple functions such as reduction of the loss during transmission, improvement of the effective illumination, easy assembling, better optical efficiency and higher use efficiency.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A light-emitting diode (LED) illumination device comprising a LED array and a holder, wherein
the LED array having a plurality of light emitting diode (LED) arranged in a specific pattern,
the holder covered in front of the LED array and having a plate that is facing the LED array and is disposed with a hole array; the hole array includes a plurality of holes arranged in specific pattern; a plurality of second lenses corresponding to the LED is mounted in the holes of the hole array correspondingly so as to integrate with the plate and form a second lens array on the plate;
when light is emitted from the LED of the LED array, the light passes through the second lens of the second lens array to be projected.

2. The device as claimed in claim 1, wherein the specific pattern of the LED array is designed according to requirements of application fields of the LED illumination device.

3. The device as claimed in claim 1, wherein the specific pattern of the LED array is a linear pattern, an array pattern or a concentric circle pattern.

4. The device as claimed in claim 1, wherein the hole array and the LED array are symmetrical.

5. The device as claimed in claim 1, wherein the plurality of light emitting diode (LED) of the LED array is with or without the same specification.

6. The device as claimed in claim 1, wherein the holes of the hole array are with or without the same shape as well as size.

7. The device as claimed in claim 1, wherein the plurality of second lenses mounted in the holes of the hole array are with or without the same specification.

8. The device as claimed in claim 1, wherein the second lens and the hole are connected and fixed by glue.

9. The device as claimed in claim 1, wherein the LED and the corresponding second lens are integrated by a barrel.

10. The device as claimed in claim 9, wherein a flange is disposed around circumference of the second lens so as to lock with an upper edge of the barrel and thus the second lens is assembled on top of the barrel.
